(19) United States
(12) Patent Application Publication
(10) Pub. No.: US 2026/0335915 A1
(43) Pub. Date: Oct. 29, 2026

(54) BEAD FLOW CONTROL SYSTEM

(71) Applicant: Core Equipment Inc., St. Catherines (CA)

(72) Inventors: Alexander Mooren, St. Catharines (CA); Joseph Barbas, St. Catharines (CA)

(73) Assignee: Core Equipment Inc., St. Catherines (CA)

(21) Appl. No.: 19/652,408

(22) Filed: Apr. 20, 2026

Related U.S. Application Data
(60) Provisional application No. 63/793,964, filed on Apr. 24, 2025.

(51) Int. Cl. B05B 7/14

(52) U.S. Cl. CPC B05B 7/1486

(57) ABSTRACT

A bead flow control system has a power unit, an air compressor powered by the power unit; a pilot operated regulator for receiving compressed air; and a constant pressure regulator for controlling operating pressure of the pilot operated regulator. The pilot operated regulator feeds regulated air to a glass bead tank. A bead gun receives glass beads from the glass bead tank. A motor and controller are used for controlling a needle opening of the bead gun and glass bead flow from the bead gun.

### CLAIM OF PRIORITY

This application claims priority to Provisional Application Serial no. 63/793,964 filed on Apr. 24, 2025, the entirety of which is hereby incorporated by reference herein.

### BACKGROUND OF THE DISCLOSURE

The present disclosure relates to glass bead flow related to road marking.

Currently common practice in road marking equipment is to control the flow of reflective glass beads using adjustments to air pressure within a pressure vessel containing the material.

Flow of material through the system has been observed as being largely inconsistent, and pressure change does not create linear adjustment characteristics. In addition, most systems cannot increase or decrease system pressure fast enough to compensate for changes in road speed, often causing inconsistent material application.

Referring to FIG. 1, the operation of a typical glass bead system 10 on road marking equipment is shown.

In the system, a power unit powers an air compressor 12 (typically either direct or hydraulically driven by the power unit). Compressed air (shown in blue) is fed to a pilot operated regulator 16 and a smaller control regulator 14. The control regulator 14 can be either manually or electronically controlled. The pilot operated regulator 16, taking its operating pressure from the control regulator, feeds regulated air (shown in dashed lines) downstream to the glass bead tank or pressure vessel 18. This pressurizes the bead tank to the regulated pressure.

The regulated pressure in the bead tank 18 forces material (glass beads; shown in green) out of the bottom of the tank through piping 19 and to the glass bead gun 20. The glass bead gun is triggered on/off using an electrically controlled on/off pneumatic valve 22. Material flow adjustment is performed by adjusting the control regulator 14 or adjusting the needle opening distance manually at the bead gun 20.

Adjusting material flow through pressure control has many drawbacks. Adjusting the pressure not only changes flow but also the velocity of the material as it moves through the lines and exits the bead gun. It is not typically desirable to adjust material velocity however it is a consequence of adjusting pressure.

The only other material flow adjustment available is the adjustment of the needle opening distance within the bead gun itself. This is adjusted by means of an adjusting screw located on the top of the gun. It can only be adjusted manually while the equipment is stopped, not allowing for any kind of electronic control while the equipment is operating.

Thus, there is a need for a new and improved glass bead flow control system which overcomes the above mentioned deficiencies and others while providing better overall results.

### SUMMARY OF THE DISCLOSURE

The present disclosure is related to glass bead flow. In particular, it relates to adding a motor to the bead gun to make adjustments to the bead gun electronically.

In the system of the present disclosure, a power unit powers an air compressor (typically either direct or hydraulically driven by the power unit). Compressed air is fed to a pilot operated regulator and a smaller control regulator. The control regulator can be either manually or electronically controlled. The pilot operated regulator, taking its operating pressure from the control regulator, feeds regulated air downstream to the glass bead tank or pressure vessel. This pressurizes the bead tank to the regulated pressure.

The regulated pressure in the bead tank forces the glass bead material out of the bottom of the tank through piping and to the glass bead gun. The glass bead gun is triggered on/off using an electrically controlled on/off pneumatic valve.

The present disclosure is directed to controlling the gun’s needle opening remotely through use of an electric stepper motor, encoder, and electronic controller. Pressure will remain constant in the system and material flow will be controlled by increasing or decreasing the needle opening size. Input will be taken from the operator and the electric motor will adjust the controller by means of an encoder mounted to the electric motor.

In accordance with one aspect of the disclosure, a bead flow control system includes a power unit, an air compressor powered by a power unit; a pilot operated regulator for receiving compressed air; a constant pressure regulator which controls operating pressure of the pilot operated regulator; wherein the pilot operated regulator feeds regulated air to a pressure vessel; a bead gun which receives material from the pressure vessel and a motor and controller for controlling a needle opening and material flow of the bead gun.

In accordance with another aspect of the disclosure, a bead gun and motor mounting system includes an upper mounting plate secured to a power screw of the motor, the upper mounting plate has a central opening for receiving the screw and a lower mounting bracket comprising having an upper wall with a central opening for receiving the bead gun.

In accordance with yet another aspect of the disclosure, a method of controlling bead flow includes feeding compressed air from an air compressor to a pilot operated regulator and into a pressure vessel where the pilot operated regulator is controlled by a smaller control regulator; using regulated pressure in the pressure vessel to force glass beads from the pressure vessel to a bead gun; controlling bead flow by controlling a size for a needle opening of the bead gun via a motor and controller; and mounting the bead gun and motor to a mounting bracket.

In accordance with another aspect of the disclosure, the motor is fitted to a bead gun (such as a Kamber Model P86 bead gun), replacing an M8 needle adjustment bolt with the lead screw of the electric stepper motor.

In accordance with another aspect of the disclosure, a custom designed mounting bracket is mounted to the bead gun thereby securing the motor in place on top of the bead gun.

Still other aspects of the disclosure will become apparent upon a reading and understanding of the following detailed description.

### BRIEF DESCRIPTION OF THE DRAWINGS

FIG. 1 shows a flow chart of an existing road marking glass bead system.

FIG. 2 shows a flow chart of a road marking glass bead system with the motor and bead gun according to the present disclosure.

FIG. 3 is a perspective view of the mounting bracket in accordance with a preferred embodiment of the disclosure.

FIG. 4A illustrates a top plan view of the mounting bracket;

FIG. 4B is a front elevational view of the mounting bracket;

FIG. 4C is a bottom plan view of the mounting bracket;

FIG. 4D is a left side elevational view of the mounting bracket;

FIG. 4E is a right side elevational view of the mounting bracket;

FIG. 5 illustrates the mounting bracket in an unfolded configuration

FIG. 6 is a perspective view of a stepper motor used with the present disclosure.

FIG. 7 is a perspective view of a bead nozzle gun used with the present disclosure.

FIG. 8 is a perspective view of the mounting bracket with the motor installed.

FIG. 9 is another perspective view of the mounting bracket with the motor installed.

FIG. 10 is a bottom plan view of a motor mounting plate in accordance with another embodiment of the disclosure.

FIG. 11 is a top plan view of a motor mounting plate in accordance with another embodiment of the disclosure.

FIG. 12 is a bottom plan view of a motor mounting plate in accordance with another embodiment of the disclosure.

FIG. 13 is a front elevational view of a bead nozzle gun with an upper motor mounting plate in accordance with another aspect of the disclosure.

FIG. 14 is a front elevational view of a mounting bracket in accordance with another aspect of the disclosure.

FIG. 15 is a side elevational view of the mounting bracket of FIG. 14.

FIG. 16 is a top plan view of the mounting bracket of FIG. 14 in an unfolded configuration.

FIG. 17 is a side perspective view of the mounting bracket of FIG. 14.

FIG. 18 is a front elevational view of a bead gun with the mounting bracket of FIG. 14.

FIG. 19 is a side elevational view of the bead gun with the mounting bracket of FIG. 14; and

FIG. 20 is a perspective view of a bead gun with the mounting bracket of FIG. 14.

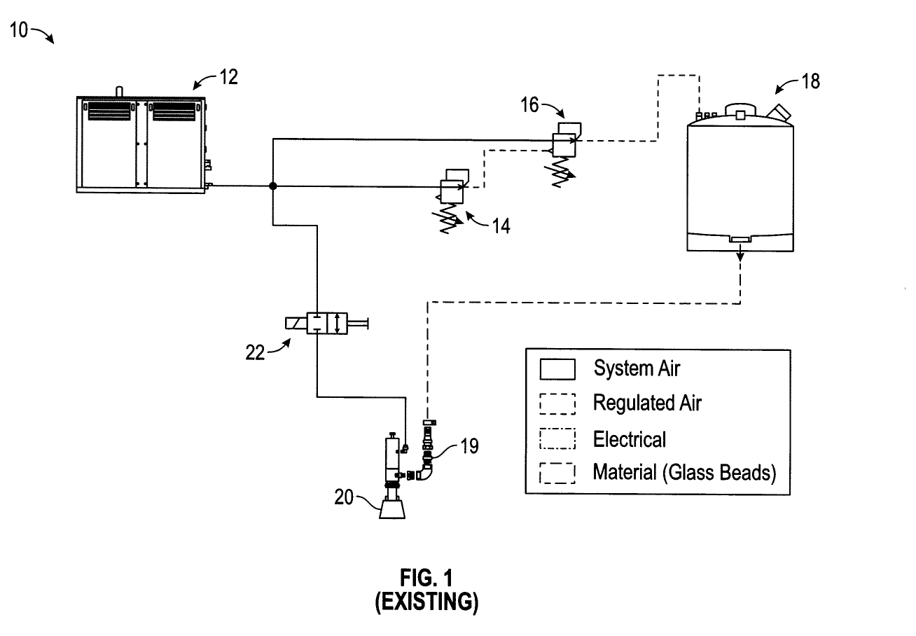

### DETAILED DESCRIPTION OF THE PREFERRED EMBODIMENT

Hereinafter, exemplary embodiments of the present invention are described in detail with reference to the accompanying drawings. Detailed description of well-known functions and structures incorporated herein may be omitted to avoid obscuring the subject matter of the present invention.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms "a," "an," and "the" include plural referents unless the context clearly dictates otherwise.

As used herein, the terms about, generally, and substantially are intended to encompass structural or numerical modifications which do not significantly affect the purpose of the element or number modified by such term.

As used in the specification and in the claims, the term "comprising" may include the embodiments "consisting of' and "consisting essentially of." The terms "comprise(s)," "include(s)," "having," "has," "can," "contain(s)," and variants thereof, as used herein, are intended to be open-ended transitional phrases, terms, or words that require the presence of the named ingredients /steps and permit the presence of other ingredients/steps. However, such description should be construed as also describing compositions or processes as "consisting of' and "consisting essentially of' the enumerated ingredients/steps, which allows the presence of only the named ingredient/steps, along with any impurities that might result therefrom, and excludes other ingredients/steps.

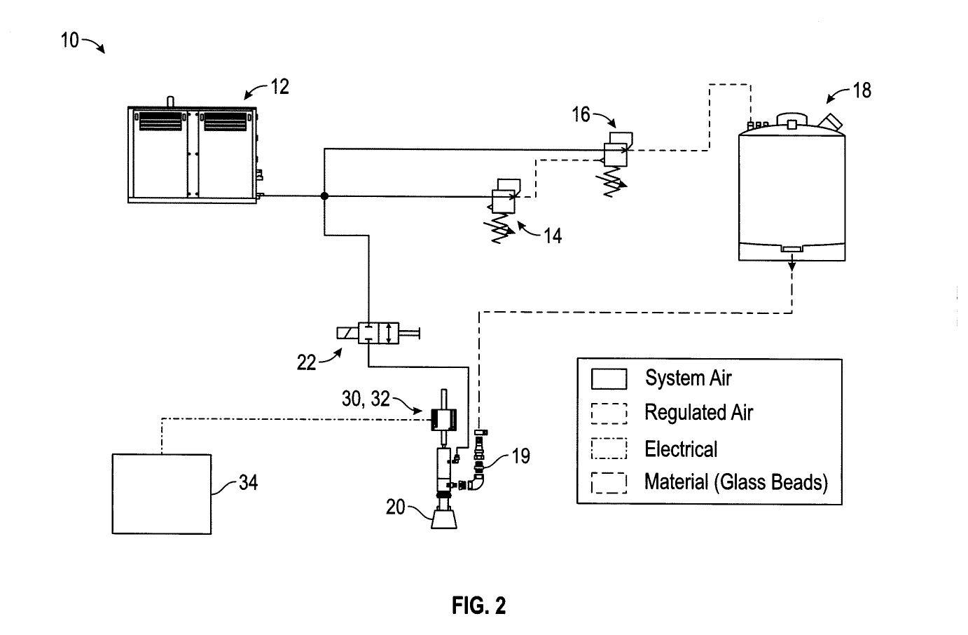

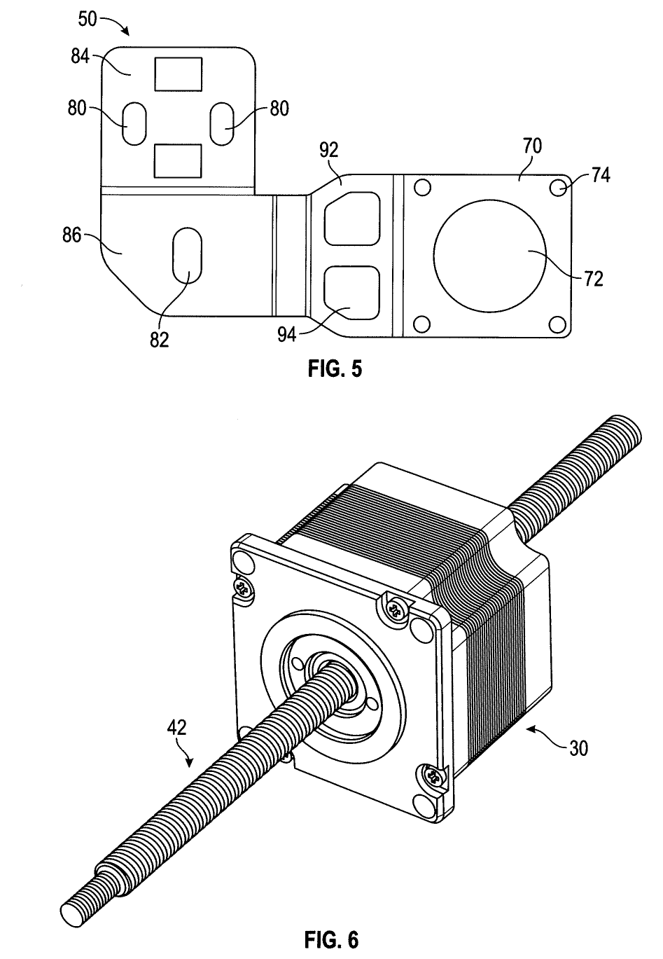

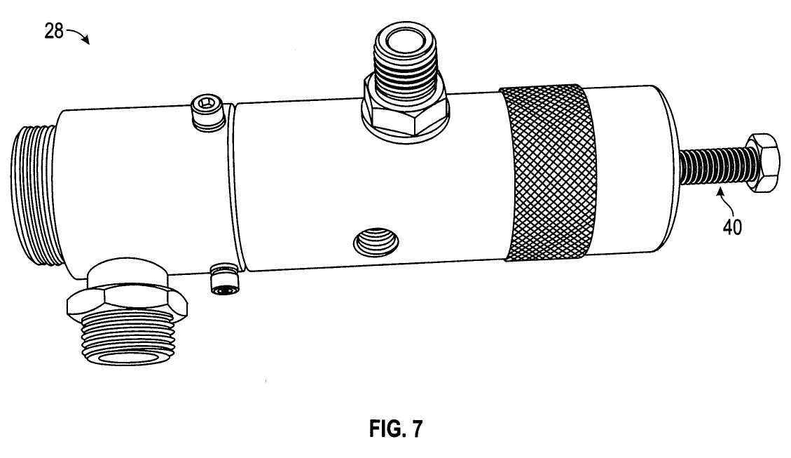

Referring to FIGS. 2-9, the present disclosure relates to a control system for bead flow to be used with road marking equipment. In particular, an electronic motor 30 will be mounted to the top of a bead gun 20 which will allow the bead gun 20 to be adjusted electronically.

The current means of deployment for a bead gun 20 is a bolt 40 which normally cannot be adapted while in use. The present disclosure will allow the gun to be adapted during use so the flow of beads through the gun can be adjusted constantly through operation.

This will allow adapting existing auto-adapting features to adjust bead flow based on vehicle speed and operate specified inputs.

Referring to FIG. 2, in the present system, a power unit powers an air compressor 12 (typically either direct or hydraulically driven by the power unit). Compressed air is fed to a pilot operated regulator 16 and a smaller control constant pressure regulator 14 (20-70 PSIG). The control regulator 14 can be either manually or electronically controlled. The pilot operated regulator 16, taking its operating pressure from the control regulator, feeds regulated air (shown in dashed lines) downstream to the glass bead tank or pressure vessel 18. This pressurizes the bead tank to the regulated pressure.

The regulated pressure in the bead tank 18 forces material (glass beads) out of the bottom of the tank through piping 19 and to the glass bead gun 20. The glass bead gun is triggered on/off using an electrically controlled on/off pneumatic valve 22. The gun’s needle opening is controlled remotely through use of the stepper motor 30, and encoder 32, and a controller 34. Pressure will remain constant in the system and material (i.e. glass bead) flow will be controlled by increasing or decreasing the needle size, direction is taken from the operator and the electric motor 30 will adjust the controller 34 by means of an encoder 32 mounted to the electric motor.

Referring now to FIG. 6, stepper motor assembly 30 will be used. The motor is a hybrid with a precursory lead screw 42 which provides high torque providing improved efficiency and reduced noise.

Referring to FIG. 9, bead nozzle gun 20 with the mounting bracket 50 to which the motor 30 is mounted is shown. The bead gun can be a Kamber Model P86 bead gun with an M8 needle adjustment bolt 40. However, other bead guns can be used as well. The glass bead spray gun is equipped with an adjuster (in orientation and width) diffuser to spread the glass beads equally over a wide lens up to 30 cm.

The diffuser can be equipped with a glass bead sensor along with a line for moving the bead material. The sensor is connected to an electronic device which manages the sprayer action.

In the present disclosure, the bolt 40 is removed from the bead gun 20 and the stepper motor 30 is mounted to the gun and the bolt 40 is replaced with lead screw 40 of the motor.

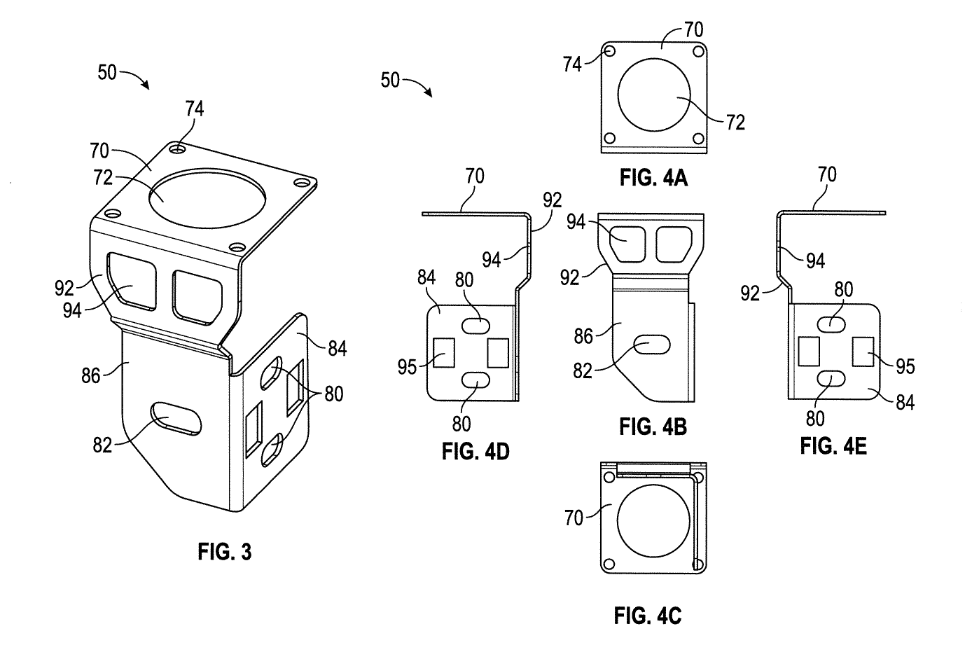

Referring now to FIGS. 3-5, mounting bracket 50 to install the motor 30 onto the bead gun 20 in accordance with a preferred embodiment of the disclosure is shown.

Specifically, the bracket 50 has an upper wall 70 with an opening 72 for receiving an upper end of the bead gun and a lower end of the stepper motor. Four holes 74 are positioned around the edges of the upper wall 70 to mount the motor via fasteners 78.

Holes 80, 82 are formed in lower walls 84, 86 to mount the bracket to the bead gun using fasteners 90, 91. Square holes 95 are used to attach welded collars to the carriage of a truck used with the gun.

An intermediate wall 92 has several openings 94 for providing access to the bead gun. The intermediate wall connects the upper and lower walls. The mounting bracket may be made out of steel or any suitable metal or even reinforced plastic.

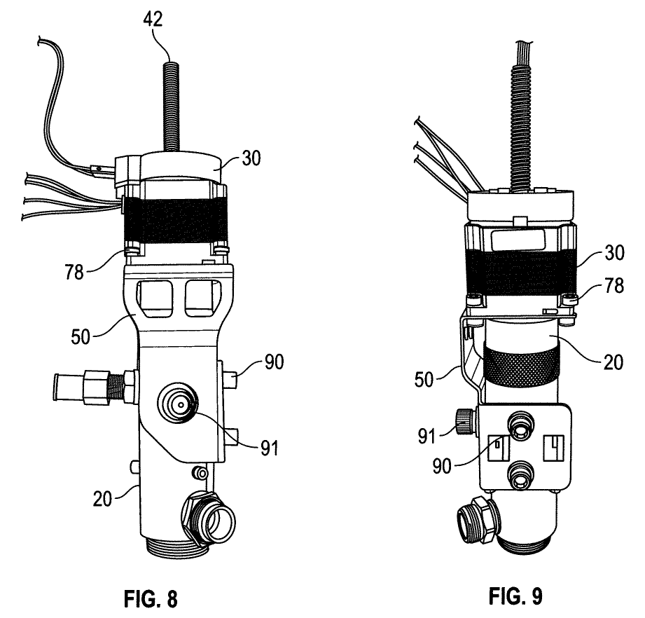

Referring to FIGS. 8 and 9, the motor 30 and bead gun 20 are shown assembled to the mounting bracket 50. The motor 30 adjusts the bead gun 20 electronically. That is, the motor allows the gun to be adjusted during use so the flow of beads through the gun is controlled constantly during operation. This allows adapting existing auto-adjustment features to adjust bead flow based on vehicle speed and operator specified inputs.

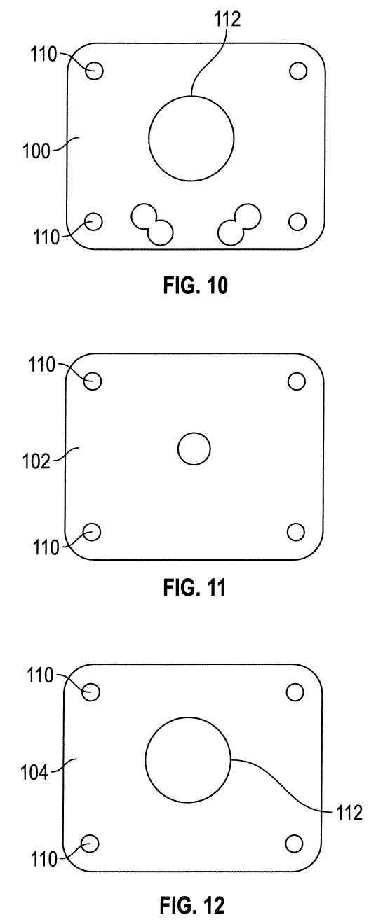

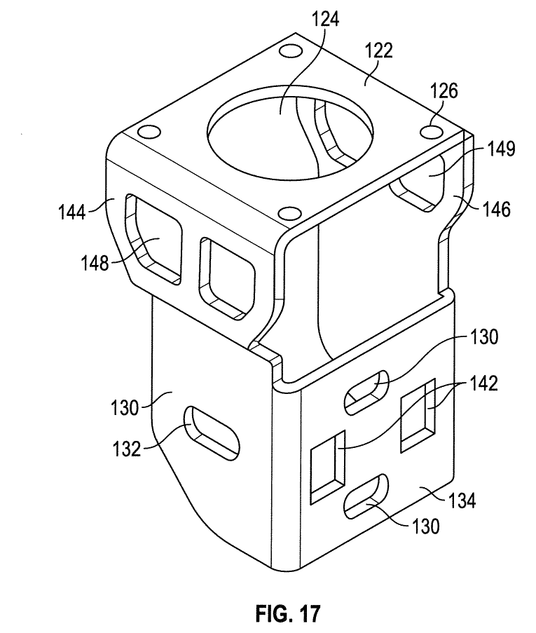

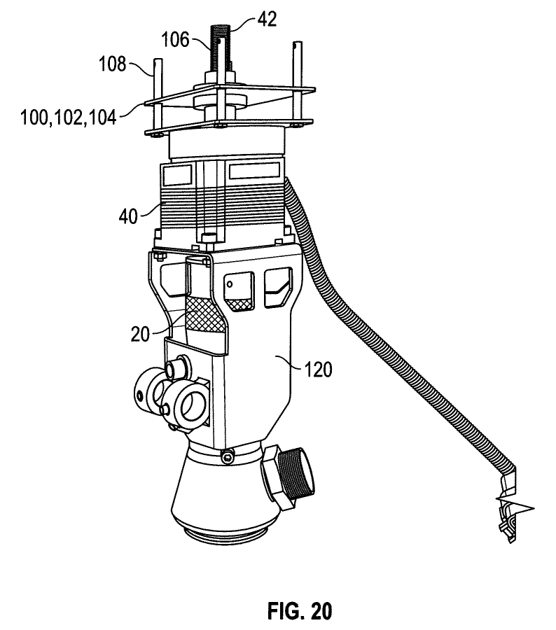

Referring to FIGS. 10-20, another aspect of the disclosure is shown.

The bead gun was wired to a 12 volt stepper motor controller 34 and commands were sent through a laptop computer to spin the motor 30 clockwise and counterclockwise. The motor 30 is able to be controlled effectively.

However, screw 42 threading into the threaded head of the bead gun can cause force to be exerted upward and create separation between the bead gun 20 and motor 30.

The rotating internal nut (not shown) turns separate from the screw 42, driving the motor 30 up and down the screw 42 rather than driving the screw in and out of the bead gun 20.

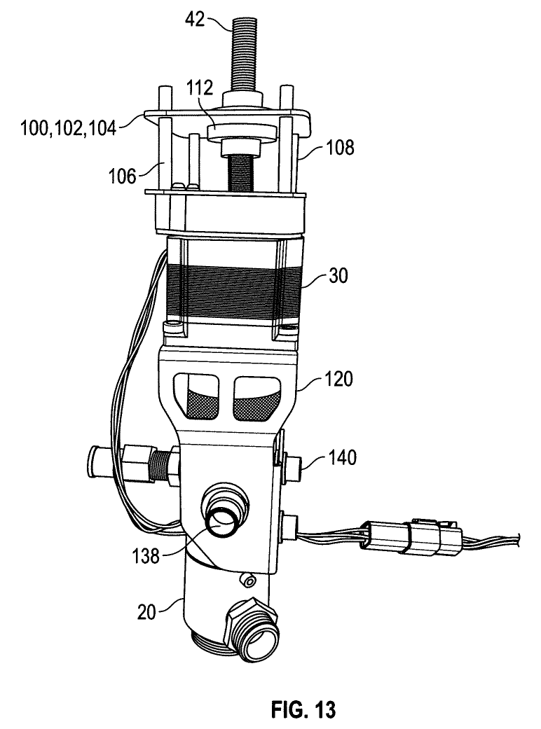

Referring to FIGS. 10-12, upper mounting plates 100, 102, 104, which slide up and down on pins are shown. These plates 100, 102, 104 are secured to the power screw by upper and lower nuts and screws 106, 108 (FIGS. 13) which extend through holes 110. Central openings 112 receive the screws 42 therethrough. This ensures that the screw rotates separately from the internal nut of the motor.

When the bead gun is opened and force is exerted on the needle, this force transferred upward to the screw and create deflection in the mounting bracket, which can cause binding of the screw.

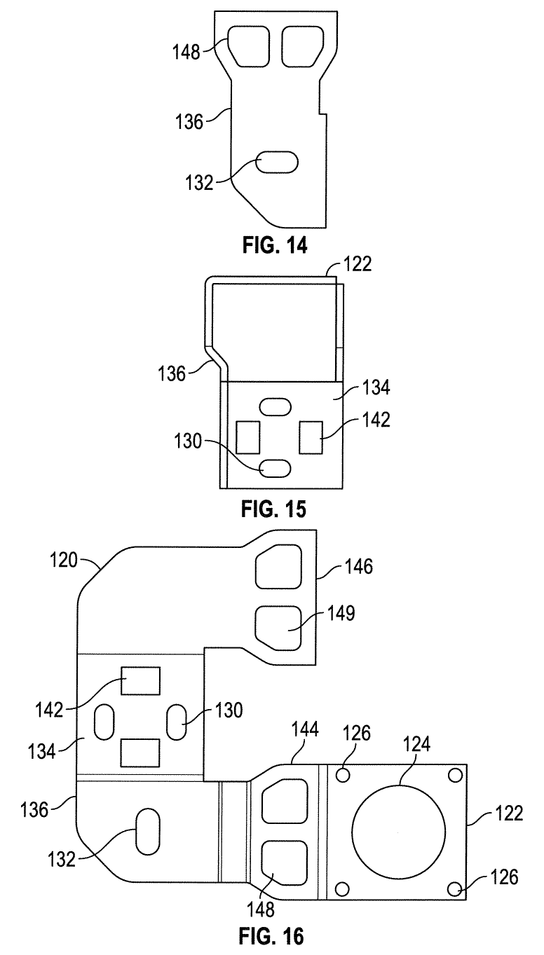

Referring to FIGS. 14-17, another embodiment of a mounting bracket 120 is secured in multiple locations rather than just one, to reduce deflection.

Additionally, the thickness of the material of bracket 120 is increased to 1/8” to reduce deflection under load. Bracket 120 has an upper wall 122 with a central opening 124 therethrough for receiving an upper end of the bead gun and a lower end of the motor. Four holes 126 are positioned around the edges of the upper wall 112 to mount the motor via fasteners 128.

Holes 130, 132 are formed in lower walls 134, 136 to mount the bracket to the bead gun using fasteners 138, 140. Square holes 142 are used to attach welded collars to the carriage of a track used with the gun.

A pair of intermediate walls 144, 146 have several openings 148, 149 for providing access to the gun. The intermediate walls connect upper and lower walls.

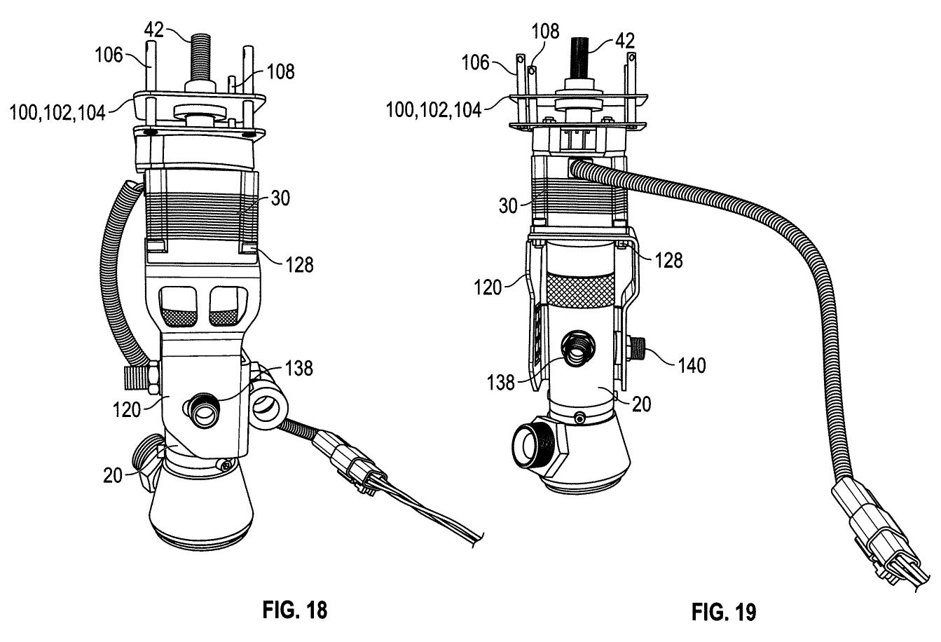

Referring to FIGS. 18-20, the bead gun 20 and motor 30 are shown assembled on the mounting bracket 120. The motor adjusts the bead gun flow electronically. That is, the motor allows the gun to be adjusted during use so that flow of beads through the gun is controlled during operation. This also allows auto-adjusted features to adjacent bead flow based on vehicle speed and operation special inputs.

Upon testing, the deflection in the mount which was previously seen is no longer an issue. The unit is functional and is able to adjust the opening of the gun needle with the needle both loaded and unload. The system also adequately holds the needle in position while under load.

The present disclosure has been described with respect to a preferred embodiment. Obviously, modifications and alterations will become apparent to others upon a reading and understanding of the specification. It is intended to include all such modifications and alterations insofar as they come within the scope of the description and the equivalents thereof.

What is claimed is:

1. A bead flow control system, comprising:
a power unit;
an air compressor powered by a power unit;
a pilot operated regulator for receiving compressed air;
a constant pressure regulator which controls operating pressure of the pilot operated regulator;
wherein the pilot operated regulator feeds regulated air to a pressure vessel;
a bead gun which receives material from the pressure vessel; and
a motor and controller for controlling a needle opening and material flow of the bead gun.

2. The bead flow control system of claim 1, wherein the motor further comprises a lead screw for providing high torque thereto.

3. The bead flow control system of claim 2, where the motor is configured to adjust the flow of material from the bead gun.

4. The bead flow control system of claim 3, further comprising a mounting bracket for the motor.

5. The bead flow control system of claim 4, wherein said mounting bracket comprises an upper wall with an opening for receiving the bead gun; and
a plurality of openings in the upper wall for mounting the motor.

6. The bead flow control system of claim 5, wherein the mounting bracket further comprises a lower wall with a plurality of openings for mounting the bead gun.

7. The bead flow control system of claim 6, wherein the mounting bracket further comprises an intermediate wall connecting the upper wall and lower wall, wherein the intermediate wall comprises a plurality of openings for accessing the bead gun.

8. The bead flow control system of claim 1, wherein the material received by the bead gun comprises glass beads.

9. A bead gun and motor mounting system, comprising:
an upper mounting plate secured to a power screw of the motor, the upper mounting plate has a central opening for receiving the screw; and
a lower mounting bracket comprising having an upper wall with a central opening for receiving the bead gun.

10. The bead gun and motor mounting system of claim 9, wherein said lower mounting bracket further comprises a lower wall with a plurality of openings for mounting the bead gun thereto.

11. The bead gun and motor mounting system of claim 9, wherein the upper wall comprises a plurality of openings for mounting the motor thereto.

12. The bead gun and motor mounting system of claim 10, further comprising a pair of intermediate walls having openings thereto to access the bead gun.

13. A method of controlling bead flow comprising:
feeding compressed air from an air compressor to a pilot operated regulator;
controlling operating pressure of the pilot operated regulator via a control regulator;
feeding regulated air from the pilot regulator into a pressure vessel;
using regulated pressure in the pressure vessel to force glass beads from the pressure vessel to a bead gun;
controlling bead flow of the bead gun by controlling a size for a needle opening of the bead gun via a motor and controller; and
mounting the bead gun and motor to a mounting bracket.

14. The method of claim 13, wherein the pressure vessel is a glass bead tank.
